(19) United States
(12) Patent Application Publication
(10) Pub. No.: US 2017/0095108 A1
(43) Pub. Date: Apr. 6, 2017

(54) BEVERAGE BREWER WITH ADJUSTABLE SHELF

(71) Applicant: Grindmaster Corporation, Louisville, KY (US)

(72) Inventor: Robert M. Ench, Louisville, KY (US)

(21) Appl. No.: 15/282,288

(22) Filed: Sep. 30, 2016

Related U.S. Application Data
(60) Provisional application No. 62/237,301, filed on Oct. 5, 2015.

(51) Int. Cl. A47J 31/44; A47J 31/10; A47J 31/46

(52) U.S. Cl. CPC A47J 31/4403; A47J 31/46; A47J 31/10

(57) ABSTRACT

A beverage brewer comprises a housing, with a spray head mounted to the housing and operably connected to a source of water. A brew basket is selectively installed and secured to the housing, with the brew basket holding a quantity of a beverage component below the spray head, such that water introduced by the spray head contacts and passes through the beverage component to produce a brewed beverage. A shelf supports a receptacle below the brew basket. The shelf includes a frame that is configured for mounting at multiple locations on the housing, i.e., at multiple vertical positions between the base portion of the housing and the brew basket. The shelf also includes a platform that is mounted to and supported by the frame.

### CROSS-REFERENCE TO RELATED APPLICATIONS

The present application claims priority to U.S. Patent Application Ser. No. 62/237,301 filed on Oct. 5, 2015, the entire disclosure of which is incorporated herein by reference.

### BACKGROUND OF THE INVENTION

The present invention relates to a brewer for brewing a beverage, such as tea or coffee, and, more particularly, to an adjustable shelf for supporting various sizes of receptacles under the brew basket of the brewer.

In a common brewer, a brew basket holds a quantity of tea, ground coffee, or similar beverage component below a spray head. The brewer includes a plumbing system in which water is drawn from a water reservoir (or from another water source). As water is drawn from the reservoir and into a hot water tank, hot water is forced from the hot water tank to a spray head. The spray head distributes the hot water over and through the quantity of tea, ground coffee, or similar beverage component, and the brewed beverage is dispensed through an outlet orifice (or drain hole) into a cup or similar receptacle.

In the food service industry, the prompt availability of high-quality brewed beverages is a necessity. Since customers may request such beverages in sporadic intervals and in varying amounts throughout the day, it has become necessary to have large volumes of fresh beverage available on demand. At the same time, it is desirable to provide beverage dispensing capabilities at a number of locations throughout a restaurant or other location so that servers or other wait staff do not need to return to the brewer to retrieve a fresh beverage.

Thus, manufacturers of coffee brewers have developed “satellite” brewing systems. In such systems, the beverage is brewed at a central brewer, and then transported in separate and portable dispensing containers, such as urns, shuttles, airpots, or other receptacles, to various convenient locations at which the beverage can be dispensed for consumption either by food service personnel or the consumer. Thus, such a central brewer needs to be able to accommodate various sizes of receptacles. For instance, it would be undesirable for the top of the urn, shuttle, airpot, or other receptacle to be separated by a significant distance from the brew basket because of the increased likelihood of splashed or spilled beverage. Rather, it is optimal to have the upper opening of the urn, shuttle, airpot, or other receptacle directly below the outlet orifice of the brew basket.

### SUMMARY OF THE INVENTION

The present invention is a beverage brewer with an adjustable shelf for accommodating urns, shuttles, airpots, and other receptacle of various sizes.

An exemplary brewer made in accordance with the present invention includes a housing, along with a brew basket that is selectively installed and secured to the housing and holds a quantity of tea, ground coffee, or similar beverage component below a spray head installed in the housing. As with prior art brewer constructions, the brewer also includes a plumbing system in which water is drawn from a water reservoir (or from another source of water). As water is drawn from the reservoir and into a hot water tank, hot water is forced from the hot water tank to the spray head. The spray head distributes the hot water over and through the quantity of tea, ground coffee, or similar beverage component held in the brew basket, and the brewed beverage is dispensed through an outlet orifice (or drain hole) into a cup or similar receptacle.

An exemplary brewer made in accordance with the present invention also includes an adjustable shelf. In one exemplary embodiment, the adjustable shelf is generally comprised of a frame with a platform mounted to and supported by the frame. The frame includes a lower portion, which defines a substantially horizontal plane that serves as the support for the platform. The frame further includes first and second arms that are positioned at a spaced distance from one another. These first and second arms extend from the rear of the lower portion, upward and at an angle relative to the substantially horizontal plane defined by the lower portion. Finally, the frame includes an upper portion, which has a generally C-shape and connects the distal ends of the first and second arms. This upper portion of the frame also defines a substantially horizontal plane, which is generally parallel to and above the substantially horizontal plane defined by the lower portion of the frame.

As a result of such a construction, the upper portion of the frame wraps around and engages a rear surface of the housing of the brewer. The distance between the first and second arms is substantially the same as the width of the housing of the brewer, such that the first and second arms are positioned against the side surfaces of the housing, while the lower portion of the frame is positioned and effectively extends from a front surface of the housing. As a result of such a construction, the force applied to the platform supported by the frame (i.e., the weight of the one or more urns, shuttles, airpots, or other receptacles on the platform) is translated through the first and second arms and countered by the engagement of the upper portion of the frame with the rear surface of the housing of the brewer.

Furthermore, in some embodiments, there are multiple aligned pairs of holes defined through the rear surface of the housing at predetermined heights relative to the base portion. The frame includes corresponding holes defined through the upper portion of the frame. Thus, the frame can be fixed at a selected height relative to the base portion by inserting screws (or similar fasteners) through the holes defined through the upper portion of the frame and then into a selected pair of holes defined through the rear surface of the housing. This fixes the position of the frame and prevents it from sliding down the housing of the brewer.

The adjustable shelf of the present invention can thus be mounted at multiple locations on the housing, i.e., at multiple vertical positions between the base portion of the housing and the brew basket, and thus allows receptacles of various sizes to be positioned directly below the outlet orifice of the brew basket.

### DESCRIPTION OF THE DRAWINGS

FIG. 1 is a perspective view of an exemplary brewer made in accordance with the present invention, in which the adjustable shelf of the brewer supports two urns side-by-side;

FIG. 2 is a perspective view of the exemplary brewer of FIG. 1, in which the adjustable shelf of the brewer supports two taller urns side-by-side;

FIG. 3 is a perspective view of the exemplary brewer of FIG. 1, in which the adjustable shelf of the brewer supports an airpot;

FIG. 4 is a perspective view of the frame of the adjustable shelf of the exemplary brewer of FIG. 1;

FIG. 5 is a rear perspective view of the exemplary brewer of FIG. 1; and

FIG. 6 is a rear perspective view similar to FIG. 5, but shows an alternate support means for the frame of the adjustable shelf.

### DETAILED DESCRIPTION OF THE INVENTION

The present invention is a beverage brewer with an adjustable shelf for accommodating urns, shuttles, airpots, and other receptacle of various sizes.

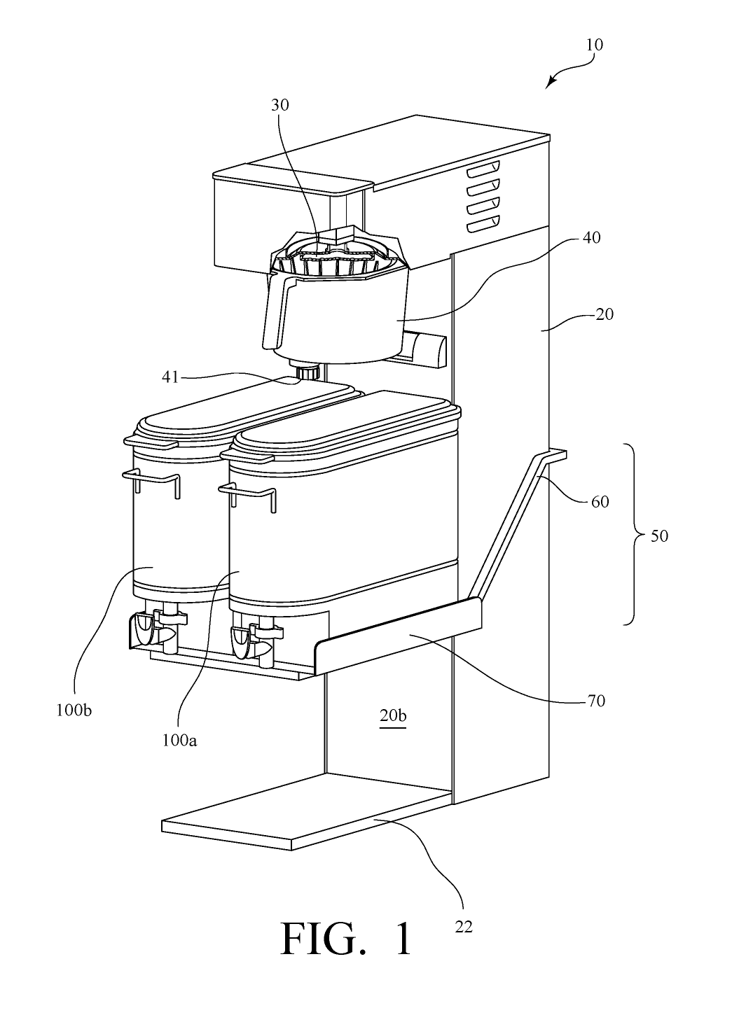

Referring first to FIGS. 1-3, an exemplary brewer 10 made in accordance with the present invention includes a housing 20, along with a brew basket 40 that is selectively installed and secured to the housing 20 and holds a quantity of tea, ground coffee, or similar beverage component below a spray head 30 installed in the housing 20. As with prior art brewer constructions, the brewer 10 also includes a plumbing system in which water is drawn from a water reservoir (or from another source of water). As water is drawn from the reservoir and into a hot water tank, hot water is forced from the hot water tank to the spray head 30. The spray head 30 distributes the hot water over and through the quantity of tea, ground coffee, or similar beverage component held in the brew basket 40, and the brewed beverage is dispensed through an outlet orifice (or drain hole) 41 into a cup or similar receptacle.

Referring now specifically to FIG. 1, the brewer 10 also includes an adjustable shelf 50, which, in this case, is positioned intermediate a base portion 22 of the housing 20 and the brew basket 40 and is supporting two urns 100a, 100b side-by-side.

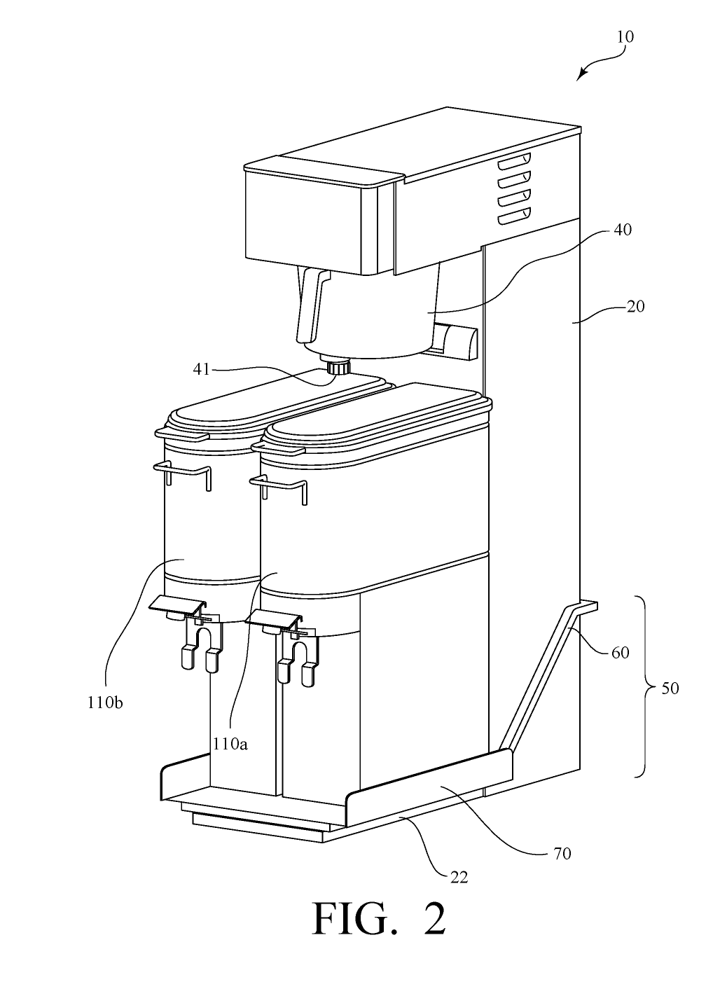

In FIG. 2, the adjustable shelf 50 is positioned adjacent the base portion 22 of the housing 20 to support taller side-by-side urns 110a, 110b.

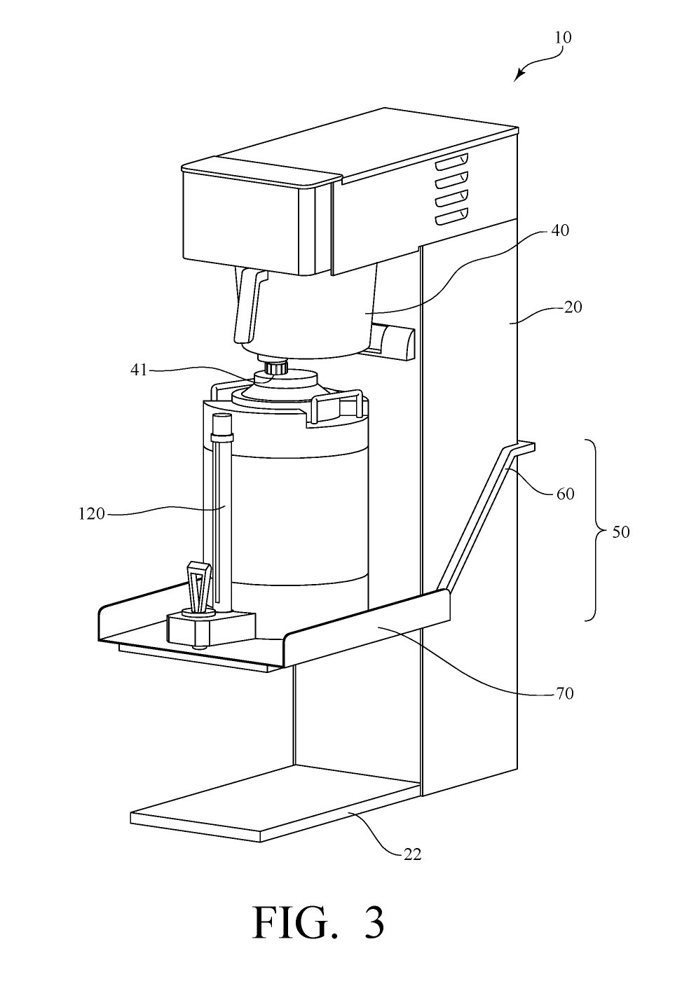

In FIG. 3, the adjustable shelf 50 is again positioned intermediate the base portion 22 of the housing 20 and the brew basket 40, but, in this case, is supporting an airpot 120.

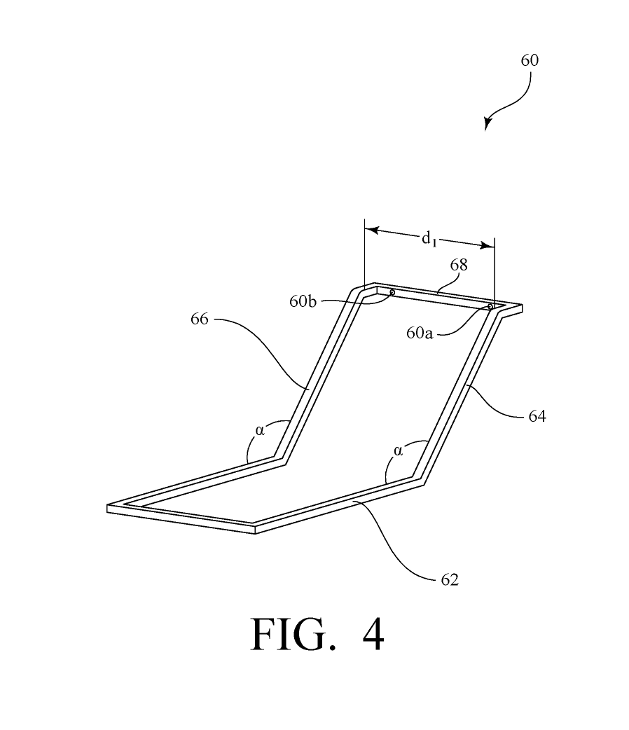

Referring now to FIG. 4, the adjustable shelf 50 is generally comprised of a frame 60 with a platform 70 (as shown in FIGS. 1, 2, 3, and 5) mounted to and supported by the frame 60. With respect to the frame 60, in this exemplary embodiment, the frame 60 includes a lower portion (forming three sides of a rectangle) 62, which defines a substantially horizontal plane that serves as the support for the platform 70. The frame 60 further includes first and second arms 64, 66 that are positioned at a spaced distance, d₁, from one another. These first and second arms 64, 66 extend from the rear of the lower portion 62 upward and at an angle, α, relative to the substantially horizontal plane defined by the lower portion 62. In this case, the angle, α, is an obtuse angle of approximately 135°. Finally, the frame 60 includes an upper portion 68, which has a generally C-shape and connects the distal ends of the first and second arms 64, 66. This upper portion 68 of the frame 60 also defines a substantially horizontal plane, which is generally parallel to and above the substantially horizontal plane defined by the lower portion 62 of the frame 60.

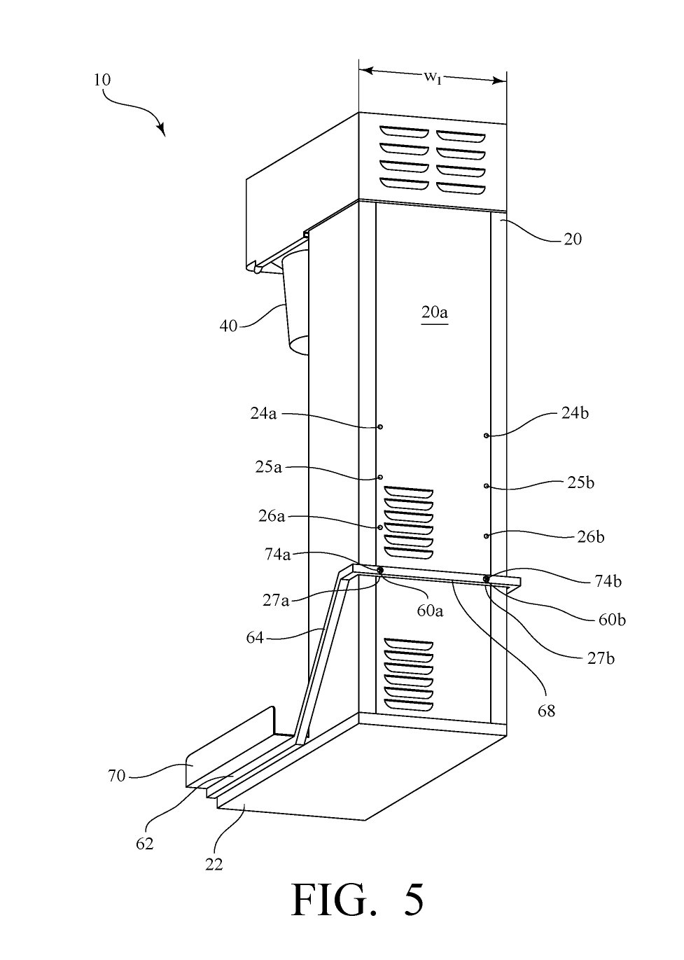

As a result of such a construction, and perhaps as best shown in FIG. 5, the upper portion 68 of the frame 60 wraps around and engages a rear surface 20a of the housing 20 of the brewer 10. The distance, d₁, between the first and second arms 64, 66 is substantially the same as the width, w₁, of the housing 20 of the brewer 10, such that the first and second arms 64, 66 are positioned against the side surfaces of the housing 20, while the lower portion 62 of the frame 60 is positioned and effectively extends from a front surface 20b of the housing 20. As a result of such construction, the force applied to the platform 70 supported by the frame 60 (i.e., the weight of the one or more urns, shuttles, airpots, or other receptacles on the platform 70) is translated through the first and second arms 64, 66 and countered by the engagement of the upper portion 68 of the frame 60 with the rear surface 20a of the housing 20 of the brewer 10.

As shown in FIG. 5, in this exemplary embodiment, there are multiple aligned pairs of holes 24a, 24b, 25a, 25b, 26a, 26b, 27a, 27b defined through the rear surface 20a of the housing 20 at predetermined heights relative to the base portion 22. As shown in FIG. 4, the frame 60 includes corresponding holes 60a, 60b defined through the upper portion 68 of the frame 60. Thus, and referring again to FIG. 5, the frame 60 can be fixed at a selected height relative to the base portion 22 by inserting screws 74a, 74b (or similar fasteners) through the holes 60a, 60b defined through the upper portion 68 of the frame 60 and then into a selected pair of holes 24a, 24b, 25a, 25b, 26a, 26b, 27a, 27b defined through the rear surface 20a of the housing 20. This fixes the position of the frame 60 and prevents it from sliding down the housing 20 of the brewer 10.

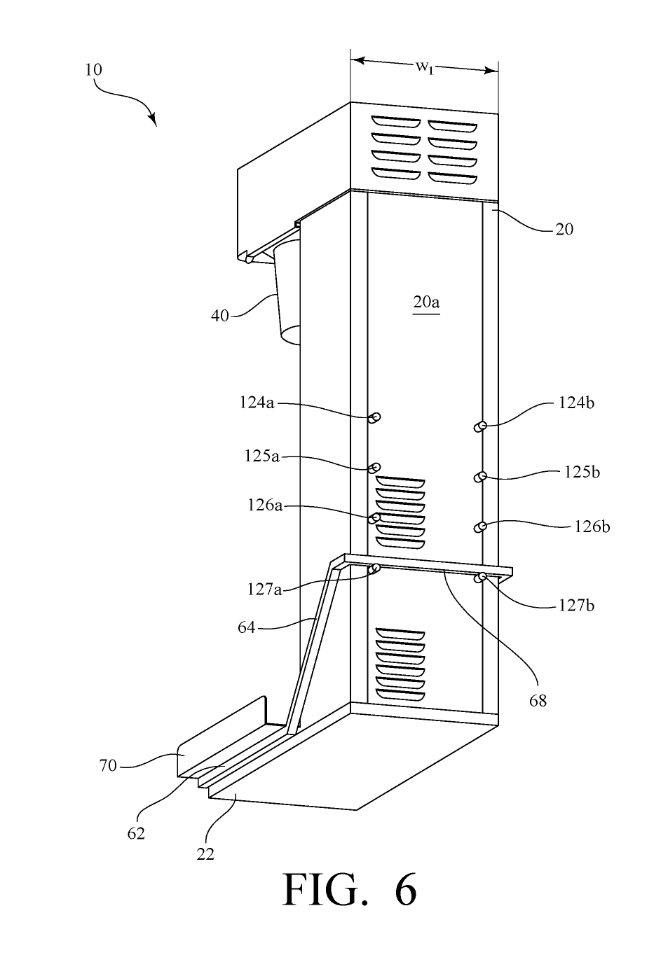

Referring now to FIG. 6, in an alternate embodiment, there are multiple aligned pairs of stops 124a, 124b, 125a, 125b, 126a, 126b, 127a, 127b extending from the rear surface 20a of the housing 20 at predetermined heights relative to the base portion 22. Thus, the frame 60 can be positioned at a selected height relative to the base portion 22 with the upper portion 68 of the frame 60 resting on and supported by a selected pair of stops 124a, 124b, 125a, 125b, 126a, 126b, 127a, 127b. Furthermore, other forms of attachment or support could also be used to fix the height of the frame 60 relative to the base portion 22 without departing from the spirit and scope of the present invention.

The adjustable shelf 50 of the present invention can thus be mounted at multiple locations on the housing 20, i.e., at multiple vertical positions between the base portion 22 of the housing and the brew basket 40, and thus allows receptacles of various sizes to be positioned directly below the outlet orifice 41 of the brew basket 40. Again, as described above, in FIG. 1, the adjustable shelf 50 is positioned intermediate a base portion 22 of the housing 20 and the brew basket 40 and is supporting two urns 100a, 100b side-by-side. In FIG. 2, the adjustable shelf 50 is positioned adjacent the base portion 22 of the housing 20 to support taller side-by-side urns 110a, 110b. In FIG. 3, the adjustable shelf 50 is again positioned intermediate the base portion 22 of the housing 20 and the brew basket 40, but, in this case, is supporting an airpot 120.

One of ordinary skill in the art will recognize that additional embodiments are possible without departing from the teachings of the present invention. This detailed description, and particularly the specific details of the exemplary embodiment disclosed therein, is given primarily for clarity of understanding, and no unnecessary limitations are to be understood therefrom, for modifications will become obvious to those skilled in the art upon reading this disclosure and may be made without departing from the spirit or scope of the present invention.

What is claimed is:

1. A beverage brewer, comprising:
a housing;
a spray head mounted to the housing and operably connected to a source of water;
a brew basket that is selectively installed and secured to the housing, said brew basket holding a quantity of a beverage component below the spray head, such that, in use, water introduced by the spray head contacts and passes through the beverage component to produce a brewed beverage; and
a shelf for supporting a receptacle that receives the brewed beverage from the brew basket, the shelf including a frame that is configured for mounting at multiple locations on the housing, along with a platform mounted to and supported by the frame.

2. The beverage brewer as recited in claim 1, wherein the frame of the shelf includes:
a lower portion which defines a substantially horizontal plane and supports the platform;
first and second arms which extend from the rear of the lower portion upward and at an angle relative to the substantially horizontal plane defined by the lower portion; and
an upper portion which connects the distal ends of the first and second arms, such that a force applied to the platform supported by the frame is translated through the first and second arms and countered by the engagement of the upper portion of the frame with a rear surface of the housing of the beverage brewer.

3. The beverage brewer as recited in claim 2, wherein the first and second arms are positioned at a spaced distance from one another, and wherein the spaced distance is substantially the same as a width of the housing of the beverage brewer.

4. The beverage brewer as recited in claim 2, wherein the angle at which the first and second arms extend from the rear of the lower portion relative to the substantially horizontal plane defined by the lower portion is approximately 135°.

5. A beverage brewer, comprising:
a housing;
a spray head mounted to the housing and operably connected to a source of water;
a brew basket that is selectively installed and secured to the housing, said brew basket holding a quantity of a beverage component below the spray head, such that, in use, water introduced by the spray head contacts and passes through the beverage component to produce a brewed beverage; and
a shelf for supporting a receptacle that receives the brewed beverage from the brew basket at a selected one of multiple vertical positions relative to the brew basket.

6. The beverage brewer as recited in claim 5, wherein the shelf is comprised of a frame and a platform mounted to and supported by the frame.

7. The beverage brewer as recited in claim 6, wherein the frame of the shelf includes:
a lower portion which defines a substantially horizontal plane and supports the platform;
first and second arms which extend from the rear of the lower portion upward and at an angle relative to the substantially horizontal plane defined by the lower portion; and
an upper portion which connects the distal ends of the first and second arms, such that a force applied to the platform supported by the frame is translated through the first and second arms and countered by the engagement of the upper portion of the frame with a rear surface of the housing of the beverage brewer.

8. The beverage brewer as recited in claim 7, wherein the first and second arms are positioned at a spaced distance from one another, and wherein the spaced distance is substantially the same as a width of the housing of the beverage brewer.

9. The beverage brewer as recited in claim 7, wherein the angle at which the first and second arms extend from the rear of the lower portion relative to the substantially horizontal plane defined by the lower portion is approximately 135°.
